(19) United States
(12) Patent Application Publication
(10) Pub. No.: US 2015/0166859 A1
(43) Pub. Date: Jun. 18, 2015

(54) HIGH FILLER CONTENT COMPOSITION BASED ON SILANE-TERMINATED POLYMERS

(71) Applicant: SIKA TECHNOLOGY AG, Baar (CH)

(72) Inventors: Fabien Choffat, Ruttenen (CH); Manuel Nestler, Uster (CH)

(21) Appl. No.: 14/413,159

(22) PCT Filed: Jul. 12, 2013
(86) PCT No.: PCT/EP2013/064848

§ 371 Date: Jan. 6, 2015

(30) Foreign Application Priority Data
Jul. 13, 2012 (EP) 12176397.3

(51) Int. Cl. C09J 175/08; C09D 175/08; C08K 5/10; C08K 3/26

(52) U.S. Cl. CPC C09J 175/08; C08K 3/26; C09D 175/08; C08K 5/10; C08K 2003/265

(57) ABSTRACT

A moisture-cure composition is described that includes

a) at least one silane-functional polymer P;
b) at least one catalyst for cross-linking of silane functional polymers; and
c) at least 65% w/w of at least one filler,
wherein the composition in the fully cured state has a Shore A hardness of ≧60, determined in accordance with DIN 53505, and prior to curing has an extrusion pressure of ≦1000 N.

### TECHNICAL FIELD

The invention relates to moisture-cure compositions based on silane-functional polymers with high filler content suitable for use as adhesives, sealants or coatings.

### PRIOR ART

Moisture-cure compositions based on silane-functional polymers are known and have long been used as elastic adhesives, sealants and coatings.

Depending on the field of application and the requirements for such compositions, on one hand during the application and on the other hand after curing, these contain different constituents. Certain applications, such as parquet adhesives, waterproofing for roofs, panel bonding and the like, require particularly high hardness of the fully cured composition, wherein the hardness of the final product can be regulated in various ways.

On one hand the hardness can be increased by the selection of the polymer matrix in that polymers with a large fraction of hard segments are used and/or the cross-linking density is increased. However, this measure is elaborate, since the entire formulation of the composition must be adapted to the new constituents. Furthermore, such modifications are often associated with high costs.

On the other hand it would be conceivable to increase the hardness of a cured composition by increasing the solids content of the composition.

However, limits exist on the use of fillers in moisture-cure compositions based on silane-functional polymers. Specifically, when using high filler quantities, as would be desired to achieve high hardness and to optimize the price of the final product, the problem arises that the composition can no longer be applied because of the increased viscosity. This is particularly problematic if the composition is to be applied by hand, for example using a caulking gun with a spatula.

### PRESENTATION OF THE INVENTION

The object of the present invention therefore is to provide a moisture-cure composition based on silane-functional polymers which has a relatively high hardness in the cured state but without significant impairment of the application properties.

Surprisingly, it has now been found that compositions according to claim 1 solve this problem.

Compositions according to the invention have excellent hardness in the cured state, and nevertheless can be processed without problems. Furthermore, compositions according to the invention have the advantage that they can be obtained at low cost because of their extraordinarily high filler content.

Additional aspects of the invention form the subject matter of additional independent claims.

Particularly preferred embodiments of the invention are the subject matter of the dependent claims.

### METHODS FOR EXECUTION OF THE INVENTION

The subject matter of the present invention is a moisture-cure composition, comprising

a) at least one silane-functional polymer P,

b) at least one catalyst for cross-linking of silane-functional polymers, and

c) at least 65% w/w of at least one filler,

wherein the composition in the fully cured state has a Shore A hardness of ≧60, especially of ≧65, preferably ≧70, determined according to DIN 53505 and prior to curing in particular has an extrusion pressure of ≦1000 N, in particular ≦800 N.

The measurement methods for the given values will be described in detail in the context of the exemplary embodiments.

In the present document, substance names beginning with “poly,” such as polyol or polyisocyanate, denote substances which formally contain two or more of the functional groups occurring in their name per molecule.

In the present document, the term “polymer” includes on one hand a group of macromolecules that are chemically uniform but differ in terms of degree of polymerization, molecular weight and chain length, produced by a polyreaction (polymerization, polyaddition, polycondensation). On the other hand, the term also includes derivatives of such a group of macromolecules from polyreactions, thus compounds that were obtained by reactions, for example, additions or substitutions, of functional groups on specified macromolecules and which may be chemically homogeneous or chemically inhomogeneous. The term also includes so-called prepolymers, in other words reactive oligomeric pre-adducts, the functional groups of which are involved in the construction of macromolecules.

The term “polyurethane polymer” includes all polymers produced according to the so-called diisocyanate polyaddition method. This also encompasses polymers that are nearly free or completely free from urethane groups. Examples of polyurethane polymers are polyether polyurethanes, polyester polyurethanes, polyether polyureas, polyureas, polyester polyureas, polyisocyanurates and polycarbodiimides.

In the present document, the terms “silane” or “organosilane” denote compounds which on one hand have at least one, usually two or three alkoxy groups or acyloxy groups bound directly to the silicon atom via Si—O bonds, and on the other hand at least one organic radical bound directly to the silicon atom via a Si—C bond. Such silanes are also known to the person skilled in the art as organoalkoxysilanes or organoacyloxysilanes.

Correspondingly, the term “silane group” denotes the silicon-containing group bound to the organic radical of the silane via the Si—C bond. The silanes, or their silane groups, are characterized by undergoing hydrolysis upon contact with moisture. In this process, organosilanols form, i.e., organosilicon compounds containing one or more silanol groups (Si—OH groups) and, by subsequent condensation reactions, organosiloxanes, i.e., organosilicon compounds containing one or more siloxane groups (Si—O—Si groups).

The term “silane functional” refers to compounds having silane groups. Thus, “silane functional” polymers are polymers that have at least one silane group.

The terms “aminosilanes” and “mercaptosilanes” denote organosilanes, the organic radical of which has an amino group or a mercapto group, respectively. The term “primary aminosilanes” denotes aminosilanes which have a primary amino group, thus, an NH₂ group bound to an organic radical. “Secondary aminosilanes” denotes aminosilanes that have a secondary amino group, thus an NH group, bound to two organic radicals.

In the present document, “molecular weight” means always the average molecular weight Mₙ (number-average).

In the present document, “room temperature” denotes a temperature of 23° C.

The composition according to the invention contains at least one silane functional polymer P, which in particular has end groups of formula (I).

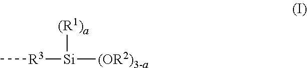

Here, radical R¹ represents a linear or branched, monovalent hydrocarbon radical with 1 to 8 C-atoms, especially a methyl or ethyl group.

Radical R² represents an acyl radical or a linear or branched, monovalent hydrocarbon radical with 1 to 5 C-atoms, especially a methyl, ethyl or isopropyl group. For certain applications, radical R² preferably represents an ethyl group, since in this case environmentally and toxicologically harmless ethanol is released during curing.

The subscript a represents a value of 0 or 1 or 2, especially a value of 0.

Radical R³ represents a linear or branched, divalent hydrocarbon radical with 1 to 12 C-atoms, which optionally has cyclic and/or aromatic moieties and optionally one or more heteroatoms, especially one or more nitrogen atoms.

Within a silane group of formula (I), R¹ and R² each independently of one another represent the radicals described. For example, compounds with end groups of formula (I) are also possible which contain ethoxy-dimethoxysilane end groups (R²=methyl, R²=methyl, R²=ethyl).

In a first embodiment the silane functional polymer P is a silane functional polyurethane polymer P1, which can be obtained by reacting a silane having at least one group that is reactive toward isocyanate groups with a polyurethane polymer that contains isocyanate groups. This reaction is preferably performed at a stoichiometric ratio of the groups reactive toward isocyanate groups of 1:1 or with a slight excess of groups reactive toward isocyanate groups, so that the resulting silane-functional polymer P1 is completely free from isocyanate groups. In the reaction of the silane having at least one group reactive toward isocyanate groups with a polyurethane polymer having isocyanate groups, the silane can theoretically, although not preferably, be used in a substoichiometric amount, so that a silane-functional polymer is obtained that has both silane groups and isocyanate groups.

The silane having at least one group reactive toward isocyanate groups is preferably a mercaptosilane or an aminosilane, especially an aminosilane.

Preferably, the aminosilane is an aminosilane AS of formula (II).

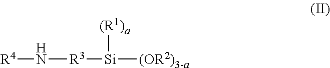

wherein R¹, R², R³ and a were already described above, and R⁴ represents a hydrogen atom or a linear or branched, monovalent hydrocarbon radical with 1 to 20 C-atoms which optionally contains cyclic moieties, or represents a radical of formula (III).

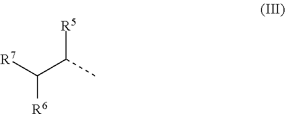

Here, radicals R⁵ and R⁶ each independently of one another represents a hydrogen atom or a radical from the group consisting of —R⁸, —COOR⁸ and —CN.

Radical R⁷ represents a hydrogen atom or a radical from the group consisting of —CH₂—COOR⁸, —COOR⁸, —CONHR⁸, —CON(R⁸)₂, —CN, —NO₂, —PO(OR⁸)₂, —SO₂R⁸ and —SO₂OR⁸.

Radical R⁸ represents a hydrocarbon radical with 1 to 20 C-atoms, optionally containing at least one heteroatom.

Examples of suitable aminosilanes AS are primary aminosilanes such as 3-aminopropyl-trimethoxysilane, 3-aminopropyldimethoxymethylsilane; secondary aminosilanes such as N-butyl-3-aminopropyltrimethoxysilane, N-phenyl-3-aminopropyltrimethoxysilane; the products from the Michael-like addition of primary aminosilanes such as 3-aminopropyltrimethoxysilane or 3-aminopropyldimethoxymethylsilane to Michael acceptors such as acrylonitrile, (meth)acrylic acid esters, (meth)acrylic acid amides, maleic acid and fumaric acid esters, citraconic acid diesters and itaconic acid diesters, for example N-(3-trimethoxysilyl-propyl)-amino-succinic acid dimethyl and diethyl esters; as well as analogs of the aminosilanes mentioned with ethoxy or isopropoxy groups in place of the methoxy groups at the silicon, especially with ethoxy groups. Particularly suitable as aminosilanes AS are secondary aminosilanes, especially aminosilanes AS, in which R⁴ in formula (II) is different from H. The Michael-type adducts are preferred, especially N-(3-trimethoxysilyl-propyl)-amino-succinic acid diethyl ester.

In the present document, the term “Michael acceptor” denotes compounds that are capable, because of the double bonds present in them which are activated by electron acceptor radicals, of undergoing nucleophilic addition reactions with primary amino groups (NH₂groups) in a manner analogous to the Michael addition (hetero-Michael addition).

For example, polymers suitable as isocyanate group-containing polyurethane polymers for producing a silane functional polyurethane polymer P1 are those that can be obtained by the reaction of at least one polyol with at least one polyisocyanate, especially a diisocyanate. This reaction can be performed by reacting the polyol and the polyisocyanate by usual methods, for example at temperatures of 50° C. to 100° C., optionally using suitable catalysts, wherein the polyisocyanate quantity added is such that its isocyanate groups are present in stoichiometric excess relative to the hydroxyl groups of the polyol.

In particular, the excess of polyisocyanate is selected such that after reaction of all the hydroxyl groups of the polyol, the resulting polyurethane polymer has a free isocyanate group content of 0.1 to 5% w/w, preferably 0.1 to 2.5% w/w, particularly preferably 0.2 to 1% w/w, based on the total polymer.

Optionally, the polyurethane polymer can be produced using plasticizers, wherein the plasticizers used do not contain any groups reactive toward isocyanates.

Preferred are polyurethane polymers with the free isocyanate group content mentioned, which are obtained by the reaction of diisocyanates with high molecular weight diols in an NCO:OH ratio of 1.5:1 to 2.2:1.

Suitable polyols for producing the polyurethane polymers in particular are polyether polyols, polyester polyols and polycarbonate polyols as well as mixtures of these polyols.

Particularly suitable as polyether polyols, also known as polyalkylene polyols or oligoetherols, are those that are polymerization products of ethylene oxide, 1,2-propylene oxide, 1,2- or 2,3-butylene oxide, oxetane, tetrahydrofuran or mixtures thereof, optionally polymerized with the aid of a starter molecule with two or more active hydrogen atoms, such as, water, ammonia or compounds with several OH- or NH-groups, such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline and mixtures of the compounds named. Polyoxyalkylene polyols that have a low degree of unsaturation (measured according to ASTM D-2849-69 and stated in milliequivalents of unsaturation per gram of polyol (mEq/g)), produced for example with the aid of so-called double metal cyanide complex catalysts (DMC catalysts) and polyoxyalkylene polyols with a higher degree of unsaturation, produced for example with the aid of anionic catalysts such as NaOH, KOH, CsOH or alkali alkoxides, can be used.

Particularly suitable are polyoxyethylene polyols and polyoxypropylene polyols, especially polyoxyethylene diols, polyoxypropylene diols, polyoxyethylene triols and polyoxypropylene triols. Particularly suitable are polyoxyalkylene diols or polyoxyalkylene triols with a degree of unsaturation of less than 0.02 mEq/g and with a molecular weight in the range of 1,000 to 30,000 g/mol, as well as polyoxyethylene diols, polyoxyethylene triols, polyoxypropylene diols and polyoxypropylene triols with a molecular weight of 400 to 20,000 g/mol.

Also particularly suitable are so-called ethylene oxide-terminated (“EO endcapped,” ethylene oxide-endcapped) polyoxypropylene polyols. The latter are special polyoxypropylene-polyoxyethylene polyols, obtained for example in that pure polyoxypropylene polyols, especially polyoxypropylene diols and triols, are further alkoxylated with ethylene oxide after completion of the polyoxypropylation reaction and thus have primary hydroxyl groups. In this case polyoxypropylene-polyoxyethylene diols and polyoxypropylene-polyoxyethylene triols are preferred.

Also suitable are hydroxyl group-terminated polybutadiene polyols, for example those produced by polymerization of 1,3-butadiene and allyl alcohol or by oxidation of polybutadiene, as well as hydrogenation products thereof.

Also suitable are styrene-acrylonitrile grafted polyether polyols, such as those commercially available from Elastogran GmbH, Germany, under the trade name Lupranol®.

Particularly suitable as polyester polyols are polyesters that carry at least two hydroxyl groups and are produced according to known methods, especially by polycondensation of hydroxycarboxylic acids or polycondensation of aliphatic and/or aromatic polycarboxylic acids with dihydric or polyhydric alcohols.

Particularly suitable are polyester polyols produced from dihydric to trihydric alcohols, such as 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or the anhydrides or esters thereof, such as succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic acid anhydride, isophthalic acid, terephthalic acid, dimethylterephthalate, hexahydrophthalic acid, trimellitic acid and trimellitic acid anhydride or mixtures of the aforementioned acids, as well as polyester polyols of lactones such as ε-caprolactone.

Particularly suitable are polyesterdiols, especially those prepared from adipic acid, azelaic acid, sebacic acid, dodecanedicarboxylic acid, dimer fatty acid, phthalic acid, isophthalic acid and terephthalic acid as a dicarboxylic acid, or from lactones such as ε-caprolactone and from ethylene glycol, diethylene glycol, neopentyl glycol, 1,4-butanediol, 1,6-hexanediol, dimer fatty acid diol and 1,4-cyclohexanedimethanol as a dihydric alcohol.

Suitable polycarbonate polyols in particular are those that can be obtained by reacting for example the above-mentioned alcohols, used for the construction of the polyester polyols, with dialkyl carbonates such as dimethyl carbonate, diaryl carbonates such as diphenyl carbonate or phosgene. Particularly suitable are polycarbonate diols, especially amorphous polycarbonate diols.

Additional suitable poylols are poly(meth)acrylate polyols.

Also suitable are polyhydroxy functional fats and oils, for example, natural fats and oils, especially castor oil, or polyols obtained by chemical modification of natural fats and oils, so-called oleo-chemical polyols, epoxy polyesters or epoxy polyethers obtained, for example, by epoxidation of unsaturated oils and subsequent ring opening with carboxylic acid or alcohols, or polyols obtained by hydroformylation and hydrogenation of unsaturated oils. Also suitable are polyols obtained from natural fats and oils by degradation processes such as alcoholysis or ozonolysis and subsequent chemical bonding, for example by transesterification or dimerization, of the degradation products or derivatives obtained in this way. Suitable degradation products of natural fats and oils in particular are fatty acids and fatty alcohols as well as fatty acid esters, especially the methyl esters (FAME), which can be derivatized, for example, by hydroformylation and hydrogenation to form hydroxy fatty acid esters.

Also suitable are polyhydrocarbon polyols, also known as oligohydrocarbonols, for example, polyhydroxy functional ethylene-propylene-, ethylene-butylene- or ethylenepropylenediene copolymers, such as those manufactured, for example, by Kraton Polymers, USA, or polyhydroxy functional copolymers from dienes such as 1,3-butadiene or diene mixtures and vinyl monomers such as styrene, acrylonitrile or isobutylene, or polyhydroxy functional polybutadiene polyols, for example those that can be produced by copolymerization of 1,3-butadiene and allyl alcohol and can also be hydrogenated.

Also suitable are polyhydroxy functional acrylonitrile/butadiene copolymers, for example those produced from epoxides or amino alcohols and carboxyl-terminated acrylonitrile/butadiene polymers commercially available from Emerald Performance Materials, LLC, USA, under the name of Hypro® CTBN.

These polyols mentioned preferably have an average molecular weight of 250 to 30,000 g/mol, especially 1,000 to 30,000 g/mol and an average OH functionality in the range of 1.6 to 3.

Particularly suitable polyols are polyester polyols and polyether polyols, especially polyoxyethylene polyol, polyoxypropylene polyol and polyoxypropylene-polyoxyethylene polyol, preferably polyoxyethylene diol, polyoxypropylene diol, polyoxyethylene triol, polyoxypropylene-polyoxyethylene diol and polyoxypropylene-polyoxyethylene triol.

In addition to these polyols mentioned, small quantities of low molecular weight dihydric or polyhydric alcohols such as 1,2-ethanediol, 1,2- and 1,3-propanediol, neopentyl glycol, diethylene glycol, triethylene glycol, the isomeric dipropylene glycols and tripropylene glycols, the isomeric butane diols, pentane diols, hexane diols, heptane diols, octane diols, nonanediols, decane diols, undecane diols, 1,3- and 1,4-cyclohexanedimethanol, hydrogenated bisphenol A, dimer fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher hydric alcohols, low molecular weight alkoxylation products of the aforementioned dihydric and polyhydric alcohols, as well as mixtures of the aforementioned alcohols may also be used in the production of the polyurethane polymer having terminal isocyanate groups.

Commercial polyisocyanates, in particular diisocyanates, may be used as polyisocyanates for producing the polyurethane polymer. For example, suitable diisocyanates are 1,6-hexamethylene diisocyanate (HDI), 2-methylpentamethylene-1,5-diisocyanate, 2,2,4- and 2,4,4-trimethyl-1,6-hexamethylene diisocyanate (TMDI), 1,12-dodecamethylene diisocyanate, lysine and lysine ester diisocyanate, cyclohexane1,3-diisocyanate, cyclohexane-1,4-diisocyanate, 1-isocyanato3,3,5-trimethyl5-isocyanatomethylcyclohexane (=isophorone diisocyanate or IPDI), perhydro-2,4′-diphenylmethane diisocyanate and perhydro-4,4′-diphenylmethane diisocyanate, 1,4-diisocyanato-2,2,6-trimethylcyclohexane (TMCDI), 1,3- and 1,4-bis-(isocyanatomethyl)-cyclohexane, m- and p-xylylene diisocyanate (m- and p-XDI), m- and p-tetramethyl-1,3-xylylene diisocyanate, m- and p-tetramethyl-1,4-xylylene diisocyanate, bis-(1-isocyanato-1-methylethyl)naphthalene, 2,4- and 2,6-toluylene diisocyanate (TDI), 4,4′-, 2,4′- and 2,2′-diphenylmethane diisocyanate (MDI), 1,3- and 1,4-phenylene diisocyanate, 2,3,5,6-tetramethyl1,4-diisocyanatobenzene, naphthalene-1,5-diisocyanate (NDI), 3,3′-dimethyl-4,4′diisocyanatodiphenyl (TODD, oligomers and polymers of the aforementioned isocyanates, and any mixtures of the aforementioned isocyanates.

For example, suitable silane functional polymers P1 are commercially available under the trade names Polymer ST, for example, Polymer ST50, from Hanse Chemie AG, Germany, and under the trade name Desmoseal® from Bayer MaterialScience AG, Germany.

In a second embodiment, the silane functional polymer P is a silane functional polyurethane polymer P2, obtainable by reacting an isocyanatosilane IS with a polymer that has functional end groups, especially hydroxyl groups, mercapto groups and/or amino groups, that are reactive toward isocyanate groups. This reaction takes place in a stoichiometric ratio of 1:1 of the isocyanate groups to the end groups that are reactive toward isocyanate groups, or with a slight excess of the functional end groups that are reactive toward isocyanate groups, for example, at temperatures of 20° C. to 100° C., optionally using catalysts.

Suitable isocyanatosilanes IS are compounds of formula (IV).

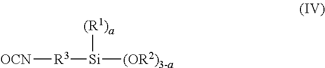

wherein R¹, R², R³ and a have been described above.

Examples of suitable isocyanatosilanes IS of formula (IV) are isocyanatomethyltrimethoxysilane, isocyanatomethyldimethoxymethylsilane, 3-isocyanatopropyltrimethoxysilane, 3-isocyanato-propyldimethoxymethylsilane, and the analogs thereof with ethoxy or isopropoxy groups in place of the methoxy groups at the silicon, especially with ethoxy groups.

The polymer preferably has hydroxyl groups as functional end groups that are reactive toward isocyanato groups.

Suitable hydroxyl group-containing polymers are on one hand the already mentioned high molecular weight polyoxyalkylene polyols, preferably polyoxypropylene diols with a degree of unsaturation less than 0.02 mEq/g and with a molecular weight in the range of 4,000 to 30,000 g/mol, especially with a molecular weight in the range of 8,000 to 30,000 g/mol.

Also suitable for reaction with isocyanatosilanes IS of formula (IV) are hydroxyl group-containing, especially hydroxyl group-terminated, polyurethane polymers. Such polyurethane polymers can be obtained by reacting at least one polyisocyanate with at least one polyol. This reaction can be performed in that the polyol and the polyisocyanate are reacted by usual methods, for example at temperatures of 50° C. to 100° C., optionally using suitable catalysts, wherein the polyol quantity added is such that the hydroxyl groups thereof are present in stoichiometric excess relative to the isocyanate groups of the polyisocyanate. A ratio of hydroxyl groups to isocyanate groups of 1.3:1 to 4:1, especially of 1.8:1 to 3:1 is preferred.

Optionally, the polyurethane polymer can be produced using plasticizers, wherein the plasticizers used do not contain any groups reactive toward isocyanates.

The same polyols and polyisocyanates that were mentioned above as suitable for producing an isocyanate group-containing polyurethane polymer which is used for producing a silane functional polyurethane polymer P1 are suitable for this reaction.

For example, suitable silane functional polymers P2 are commercially available from Momentive Performance Materials Inc., USA, under the trade name of SPUR+® 1010LM, 1015LM and 1050MM, and from Wacker Chemie AG, Germany, under the trade names of Geniosil® STP-E15, STP-10 and STP-E35.

In a third embodiment the silane functional polymer P is a silane functional polymer P3 which can be obtained by a hydrosilylation reaction of polymers with terminal double bonds, for example poly(meth)acrylate polymers or polyether polymers, especially of allyl-terminated polyoxyalkylene polymers, described for example in U.S. Pat. No. 3,971,751 and U.S. Pat. No. 6,207,766, the entire disclosure of which is herewith incorporated. For example, suitable silane functional polymers P3 are commercially available from Kaneka Corp., Japan, under the trade names MS polymer™ 5203H, 5303H, S227, S810, MA903 and S943, Silyl™ SAX220, SAX350, SAC400 and SAX725, Silyl™ SAT350 and SAT400, and XMAP™ SA100S and SA310S, as well as from Asahi Glass Co., Ltd., Japan, under the trade names Excestar® S2410, S2420, S3430, S3630, W2450 and MSX931.

The silane-functional polymer P is usually present in a quantity of 5 to 35% w/w, especially in a quantity of 5 to 25% w/w, preferably 7 to 15% w/w, most preferably 7 to 12% w/w, based on the total composition.

In addition, the composition according to the invention includes at least one catalyst for the cross-linking of silane functional polymers.

In particular, the catalyst is a metal catalyst or a nitrogen-containing compound.

Suitable metal catalysts are compounds of titanium, zirconium, aluminum or tin, especially organotin compounds, organotitanates, organozirconates and organoaluminates, wherein these metal catalysts particularly contain alkoxy groups, sulfonate groups, carboxyl groups, dialkyl phosphate groups, dialkyl pyrophosphate groups and diketonate groups.

Particularly suitable organotin compounds are dialkyltin oxides, dialkyltin dichlorides, dialkyltin carboxylates and dialkyltin diketonates, especially dibutyltin oxide, dibutyltin dichloride, dibutyltin diacetate, dibutyltin dilaurate, dibutyltin diacetyl acetonate, dioctyltin oxide, dioctyltin dichloride, dioctyltin diacetate, dioctyltin dilaurate and diocytltin diacetyl acetonate, as well as alkyltin thioesters.

Particularly suitable organotitanates are:
titanium(IV) complex compounds with two 1,3-diketonate ligands, especially 2,4-pentane-dionate (acetylacetonate), and two alkoxy ligands,
titanium(IV) complex compounds with two 1,3-ketoesterate ligands, especially ethyl-acetoacetate, and two alcoholate ligands,
titanium(IV) complex compounds with one or more aminoalkoxide ligands, especially triethanolamine or 2-((2-aminoethyl)amino)ethanol, and one or more alkoxide ligands,
titanium(IV) complex compounds with four alkoxide ligands, and
more highly fused organotitanates, especially oligomeric titanium(IV)-tetrabutanolate, also known as polybutyltitanate.

Especially suitable as alkoxide ligands are isobutoxy, n-butoxy, isopropoxy, ethoxy and 2-ethylhexoxy.

Particularly suitable are bis(ethylacetoacetato)-diisobutoxy-titanium(IV), bis(ethylacetoacetato)-diisopropoxy-titanium(IV), bis(acetylacetonato)-diisopropoxy-titanium(IV), bis(acetylacetonato)-diisobutoxy-titanium(IV), tris(oxyethyl)amine-isopropoxy-titanium(IV), bis[tris(oxyethyl)amine]-diisopropoxy-titanium(IV), bis(2-ethylhexane-1,3-dioxy)-titanium(IV), tris[2-((2-aminoethyl)amino)ethoxy]-ethoxy-titanium(IV), bis(neopentyl(diallyl)oxydiethoxy-titanium(IV), titanium(IV)-tetrabutoxide, tetra-(2-ethyl hexyloxy)titanate, tetra-(isopropoxy)titanate and polybutyl titanate. Particularly suitable are the commercially available types Tyzor® AA, GBA, GBO, AA-75, AA-65, AA-105, DC, BEAT, BTP, TE, TnBT, KTM, TOT, TPT or IBAY (all from DuPont/Dorf Ketal); Tytan PBT, TET, X85, TAA, ET, S2, S4 or S6 (all from TensoChema) and Ken-React® KR® TTS, 7, 9QS, 12, 26S, 33DS, 38[D]S, 39DS, 44, 134S, 138S, 133DS, 158FS or LICA® 44 (all from Kenrich Petrochemicals).

Particularly suitable organozirconates are the commercially available types Ken-React® NZ® 38J, KZ® TPPJ, KZ® TPP, NZ® 01, 09, 12, 38, 44 or 97 (all from Kenrich Petrochemicals) and Snapcure® 3020, 3030, 1020 (all from Johnson Matthey & Brandenberger).

A particularly suitable organoaluminate is the commercially available type K-Kat 5218 (from King Industries).

Nitrogen-containing compounds suitable as catalysts are in particular amines, especially N-ethyl-diisopropylamine, N,N,N′,N′-tetramethylalkylenediamines, polyoxyalkyleneamines, 1,4-diazabicyclo[2.2.2]octane; aminosilanes, especially 3-aminopropyl-trimethoxysilane, 3-aminopropyl-dimethoxymethylsilane, N-(2-aminoethyl)-3-aminopropyl-trimethoxysilane, N-(2-aminoethyl)-3-aminopropyl-methyldimethoxysilane, N-(2-aminoethyl)N′-[3-(trimethoxysilyl)propyl]ethylenediamine and the analogs thereof with methoxy or isopropoxy groups instead of the methoxy groups at the silicon; amidines such as especially 1,8-diazabicyclo[5.4.0]undec-7-ene (DBU), 1,5-diazabicyclo[4.3.0]non-5-ene (DBN), 6-dibutylamino1,8-diazabicyclo-[5.4.0]undec-7-ene; guanidines such as especially tetramethylguanidine, 2-guanidino-benzimidazole, acetylacetone-guanidine, 3-di-o-tolyl-guanidine, 2-tert-butyl-1,1,3,3-tetramethyl guanidine; and imidazoles, in particular N-(3-trimethoxysilylpropyl)-4,5-dihydroimidazole and N-(3-triethoxysilyl propyl)-4,5-dihydroimidazole.

Also particularly suitable are combinations of various catalysts, especially combinations of at least one metal catalyst and at least one nitrogen-containing compound.

Preferred catalysts are organotitanates, amines, amidines, guanidines and imidazoles. Particularly preferred are organotitanates and amidines.

Preferably, the composition preferably does not contain any organotin compounds for cross-linking the silane functional polymers.

If the silane-functional polymer P is one in which R² represents an ethyl group, the composition preferably comprises a catalyst system consisting of at least one organotitanate and at least one amidine. In this embodiment as well, the composition preferably does not contain any organic tin compounds for cross-linking the silane functional polymers.

The catalyst fraction amounts to 0.01 to 0.15% w/w, especially 0.05 to 0.1% w/w, based on the total composition.

Furthermore, the composition contains at least 65% w/w of at least one filler. The filler influences the rheologic properties of the non-cured composition as well as the mechanical properties and the surface texture of the cured composition. Suitable fillers are inorganic and organic fillers, for example, natural, ground or precipitated calcium carbonates, which are optionally coated with fatty acids, especially stearic acid, barium sulfate (BaSO₄, also called baryta or heavy spar), calcined kaolins, aluminum oxides, aluminum hydroxides, silicas, especially highly dispersed silicas from pyrolysis processes, carbon blacks, especially industrially manufactured carbon black (carbon black), PVC powder or hollow beads. Preferred fillers are calcium carbonates, calcined kaolins, carbon black, highly dispersed silicas and flame-retardant fillers such as hydroxides or hydrates, especially hydroxides or hydrates of aluminum, preferably aluminum hydroxide.

It is entirely possible and may even be advantageous to use a mixture of various fillers. Calcium carbonate (chalk) is most preferred as a filler for the composition according to the invention.

In particular, the fraction of filler falls in the range of 67 to 80% w/w, preferably 70 to 76 wt%, based on the total composition. Most preferably, the composition contains more than 70% w/w filler, preferably 72% w/w or more.

In addition, the composition according to the invention may also contain other constituents. For example, such constituents are plasticizers such as esters of organic carboxylic acids or anhydrides thereof, such as fatty acid esters, phthalates, for example dioctyl phthalate, diisononyl phthalate or diisodecyl phthalate, adipates, for example dioctyl adipate, azelates and sebacates, polyols, for example polyoxyalkylene polyols or polyester polyols, organic phosphoric and sulfonic acid esters or polybutenes; solvents; fibers, for example made of polyethylene; dyes; pigments; rheology modifiers such as thickeners or thixotropic agents, for example urea compounds of the type described as thixotropic agents (“Thixotropy endowing agent”) in WO 02/48228 A2 on pages 9 to 11, polyamide waxes, bentonites or pyrogenic silicas; adhesive promoters, for example epoxy silanes, (meth)acrylsilanes, anhydridosilanes or adducts of the aforementioned silanes with primary aminosilanes, as well as aminosilanes or urea silanes; cross-linking agents, for example silane-functional oligomers and polymers; drying agents, for example, vinyl triethoxysilane, a-functional silanes such as N-(silylmethyl)-O-methyl-carbamates, especially N-(methyldimethoxy silylmethyl)-O-methyl-carbamate, (methacryloxymethyl) silanes, methoxy-methylsilanes, N-phenyl-, N-cyclohexyl- and N-alkylsilanes, orthoformic acid esters, calcium oxide or molecular sieves; stabilizers, for example against heat, light and UV radiation; flame-retardant substances; surface-active substances such as wetting agents, leveling agents, deaerating agents, defoamers; biocides such as algicides, fungicides or fungal growth-inhibiting substances; and additional substances usually used in moisture-cure compositions.

In particular, the composition according to the invention contains at least one plasticizer, wherein the fraction of plasticizer amounts to 5 to 20% w/w, especially 10 to 17%, of the total composition.

In particular, the composition according to the invention also contains at least one adhesive promoter, especially an aminosilane, as was also described above for producing the silane functional polymer P. Here, the traction of the adhesive promoter preferably amounts to 0.01 to 3% w/w of the total composition.

In addition, the composition according to the invention preferably contains a wetting and/or dispersing agent. Suitable wetting and/or dispersing agents are, for example, commercially available from BYK-Chemie GmbH or Elementis Specialities under the product name Nuosperse®. The fraction of the wetting and/or dispersing agent preferably amounts to 0.2 to 3% w/w, especially 0.3 to 1% w/w, based on the total composition.

In addition, so-called reactive diluents may optionally be used, which are incorporated into the polymer matrix during curing of the composition, especially by reaction with the silane groups.

In an embodiment preferred for certain applications, for example low-emission adhesives and sealants, the composition according to the invention contains no constituents that split off methanol during curing. In addition to the silane functional polymer P such constituents are optionally present reactive constituents such as adhesive promoters, drying agents, reactive diluents, cross-linking agents and other above-described constituents. Constituents that split off methanol during curing are typically methoxy group-containing silane-functional compounds. Thus, in particular, the composition according to the invention contains no silane functional compositions that have methoxysilane groups. Preferably, all silane functional compounds present in the composition have end groups of formula (I), wherein radicals R¹, R² and R³ and index a have been described above.

Most preferably, all hydrolyzable groups present in the composition are ethoxysilane groups, especially triethoxysilane groups. In such an embodiment, the silane functional polymer P is a silane functional polymer P1 and has only triethoxysilane groups as the silane groups. Furthermore, silane-containing additives that may be present have only triethoxysilane groups or alkyldiethoxysilane groups as the silane groups, especially methyl- or ethyldioxysilane groups, and preferably triethoxysilane groups.

In a particularly preferred embodiment the composition according to the invention comprises 5 to 15% w/w of a silane-functional polymer P, especially a silane functional polyurethane polymer P1,

70 to 80% w/w of calcium carbonate as filler,

5 to 20% w/w of at least one plasticizer, especially a phthalate-free plasticizer, preferably a fatty acid alkyl ester, and

at least one catalyst for cross-linking the silane functional polymer, especially an organotitanate and/or an amidine,

wherein the composition in the fully cured state, i.e., following curing of the composition for 7 days at 23° C. and 50% relative humidity, has a Shore A hardness of ≧60, determined according to DIN 53505, and before curing, in particular, has an extrusion pressure of ≦1000 N, preferably ≦800 N. The measurement methods for the indicated values will be described in detail in the exemplary embodiments.

A composition of this type is particularly suitable as a parquet adhesive. In particular, the composition does not contain any organotin compounds as catalyst for the cross-linking of silane functional polymers. Furthermore, such a composition preferably does not contain any constituents that split off methanol during curing. Additionally, the adhesive is preferably free from phthalate-containing plasticizers.

It is advantageous to select all of the constituents optionally present in the composition, especially fillers and catalysts or accelerator system, in such a way that the storage stability of the composition is not negatively impacted by the presence of such constituents, in other words, that the composition shows little or no change during storage in its properties, especially its application and curing properties. This means that reactions leading to chemical curing of the compositions described, especially of the silane groups, do not take place to a significant extent during storage.

It is therefore particularly advantageous that the constituents mentioned do not contain, or release upon storage, any or at most traces of water. For this reason it may be suitable to chemically or physically dry certain constituents before admixing them with the composition.

The above-described composition is preferably produced and stored under exclusion of moisture. Typically, the composition is stable in storage, in other words, it can be stored under exclusion of moisture in a suitable package or system, for example a drum, a bag or a cartridge, over a period of several months up to one year or longer, without its application properties or its properties after curing changing to an extent that is relevant for its use. Usually, the storage stability is ascertained by measuring the viscosity or the extrusion pressure.

Upon application of the described composition to at least one solid or article, the silane groups contained in the composition come into contact with moisture. The silane groups are characterized in that they hydrolyze upon contact with moisture. In this process organosilanols form, and, by subsequent condensation reactions, also organosiloxanes. As a result of these reactions, which can be accelerated by the use of catalysts or accelerants, the composition finally cures. This process is also known as cross-linking. The water needed for curing can come from the air (humidity), or the above described composition can be brought into contact with a component containing water, for example by painting, for example with a smoothing agent, or by spraying, or a water-containing component can be added to the composition during its application, for example in the form of a water-containing paste.

Furthermore, the present invention comprises the use of a composition as described above as a moisture-cure adhesive, sealant or coating. The composition according to the invention is particularly suitable for application to concrete, mortar, brick, tile, plaster, natural stone such as granite or marble, glass, glass ceramic, metal or metal alloy, wood, plastic and paint.

The composition according to the invention is preferably used as a parquet adhesive, especially for solid parquet, strip parquet (tongue and groove), laminate parquet, industrial parquet, timbering, mosaic parquet, wood-block paving, and chipboard, preferably for full-surface adhesion.

The composition according to the invention preferably has a pasty consistency with structurally viscous characteristics. Such a composition is applied to the substrate using a suitable device, for example from a cartridge or from a larger container using a notched trowel. A composition according to the invention with good application characteristics has high creep strength and short stringing as well as low viscosity and extrusion pressure. In other words, it can be spread with low force using the notched trowel, after application it remains in place in the form as applied, thus does not flow away, and after the application device is lifted it does not draw a thread or draws only a very short thread, so that the substrate is not dirtied.

The composition according to the invention is especially applied in a temperature range between 5 and 45° C., preferably in the room temperature range, and also cures under these conditions.

In addition, the invention relates to a cured composition that can be obtained from a composition as described above after curing with water, especially in the form of humidity.

In this case, the cured composition has a Shore A hardness of ≧60, especially of ≧65, preferably ≧70, determined according to DIN 53505. Preferably, the cured composition has a density of ≧1.75 kg/l, especially of 1.8 kg/l, preferably of 1.85 kg/l, measured according to DIN 53479.

The articles bonded, sealed or coated with a composition according to the invention, include in particular a civil engineering construction work, above or below ground, an industrially manufactured item or a consumer item, especially a window, a household appliance, or a means of transport or a component of a transport means.

### EXAMPLES

In the following, embodiments are presented to explain the invention described in further detail. Naturally, the invention is not limited to these embodiments described.

Test Methods

The tensile strength and the elongation at break were determined according to DIN 53504 (tensile speed: 200 mm/min) on films with a layer thickness of 2 mm cured for 7 days at 23° C. and 50% relative humidity.

The Shore A hardness was determined according to DIN 53505 on test pieces with a layer thickness of 6 mm, cured for 7 days at 23° C. and 50% relative humidity

The skin formation time (“tack-free time”) was determined at 23° C. and 50% relative humidity. To determine the skin formation time a small portion of the adhesive at room temperature was applied to corrugated cardboard in a layer thickness of about 2 mm and the time measured that was required for no residue to remain on the finger after the surface of the adhesive was tapped lightly with the finger.

To determine the extrusion pressure, the compositions were packed into internally painted aluminum cartridges (external diameter 46.9 mm, internal diameter 46.2 mm, length 215 mm, opening 15-M) and closed airtight suing a polyethylene stopper (diameter 46.1 mm) from Novelis Deutschland GmbH. After conditioning for 24 hours at 23° C. the cartridges were opened and extruded using an extrusion device. For this purpose, a nozzle with an opening having an internal diameter of 2 mm was screwed onto the thread of the cartridge. Using an extrusion device (Zwick/Roell Z005) the force was determined that was required to push out the composition at an extrusion speed of 60 mm/min. The reported value is an average of the forces measured after pushing distances of 22 mm, 24 mm, 26 mm and 28 mm. The measurement was stopped after 30 mm press-out distance.

The density was determined according to DIN 53479.

Preparation of the Silane-Functional Polyurethane Polymer SH1

Under a nitrogen atmosphere, 5687 g Polyol Acclaim® 4200 (Bayer MaterialScience AG, Germany) 712 g Desmodur 44 MC L and 0.6 g DABCO 33 LV were heated under constant stirring to 80° C. and held at this temperature. After one hour of reaction time, a free isocyanate group content of 1.9% w/w by titration was reached. Then, 1070 g N-(3-trimethoxysilyl-propyl)-amino-succinic acid diethyl ester were added and stirring was continued for an additional 2 hours at 80° C. The reaction was stopped as soon as no further free isocyanate was detectable by IR spectroscopy (2275-2230 cm⁻¹). The product was cooled to room temperature (23° C.) and stored under exclusion of moisture. The silane functional polyurethane polymer SH produced in this way is liquid at room temperature.

N-(3-trimethoxysilyl-propyl)-amino-succinic acid diethyl ester was produced as follows: 51.0 g 3-aminopropyl-trimethoxysilane (Silquest® A-1110, Momentive Performance Materials Inc., USA) were charged. Stirring well, at room temperature, 49.0 mg diethyl maleate (Fluke Chemie GmbH, Switzerland) were added and the mixture was stirred for 2 hours at room temperature.

Preparation of the Silane Functional Polyurethane Polymer with Ethoxy End Groups SH2

Under a nitrogen atmosphere, 5687 g Polyol Acclaim® 4200 (Bayer MaterialScience AG, Germany) 712 g Desmodur 44 MC L and 0.6 g DABCO 33 LV were heated under constant stirring to 80° C. and held at this temperature. After one hour of reaction time, a free isocyanate group content of 1.9% w/w by titration was reached. Then, 1200 g N-(3-trimethoxysilyl-propyl)-amino-succinic acid diethyl ester were added and stirring was continued for an additional 2 hours at 80° C. The reaction was stopped as soon as no further free isocyanate was detectable by IR spectroscopy (2275-2230 cm⁻¹). The product was cooled to room temperature (23° C.) and stored under exclusion of moisture. The silane functional polyurethane polymer SH produced in this way is liquid at room temperature.

The reactive (N-(3-triethoxysilyl-propyl)-amino-succinic acid diethyl ester) was produced as follows: 100 g 3-aminopropyl-triethoxysilane (Dynasylane®AMEO from Evonik Degussa GmbH, Germany) was charged. Stirring well, at room temperature, 77.8 mg diethyl maleate (Fluke Chemie GmbH, Switzerland) were added and the mixture was stirred for 12 hours at 60° C.

Preparation of the Thixotropic Agent TM

In a vacuum mixer, 1000 g hydrogenated diisononyl phthalate (Hexamol® DINSCH, BASF) and 160 g 4,4′-diphenylmethane diisocyanate (Desmodur® 44 MC L, Bayer MaterialScience AG, Germany) were charged and slightly heated. Then, 90 g monobutylamine were added dropwise, slowly, under vigorous stirring. The resulting white paste was further stirred for 1 hour in vacuum and with cooling. The thixotropic agent TM contains 20% w/w thixotropic agent in 80% w/w diisodecyl phthalate.

Preparation of the Adhesive

Corresponding to the parts by weight given in Table 1, the silane-functional polymers SH1 and SH2, plasticizers based on rapeseed oil methyl ester, the wetting agent, thixotropic agent TM and vinyltrimethoxysilane or vinyltriethoxysilane (drying agent, Silquest® A-171 from Momentive Performance Materials or Dynasylan® VTEO from Evonik Degussa GmbH) were well mixed for 5 minutes in a vacuum mixer. Then, ground chalk (Omyacarb® 5-GU, Omya AG, Switzerland) was kneaded in for 15 minutes at 60° C. Then, with the heat turned off,

N-(2-aminoethyl)-3-aminopropyl-trimethoxysilane and 3-aminopropyl-triethoxysilane (adhesive promoters, Silquest® A—from Momentive Performance Materials or Dynasylan®AMEO from Evonik Degussa GmbH), catalyst (1,8-diazabicyclo[5.4.0]undec-7-ene (DBU) alone or together with the titanate Tyzor® IBAY from DuPont) were processed under vacuum for 10 minutes to form a homogeneous paste. This was then filled into expanding plunger aluminum cartridges painted on the inside.

TABLE 1
Compositions in parts by weight and results: n.m.: not measurable
(composition could not be pressed out of cartridge)

| | 1 | 2 | 3 | 4 | 5 | 6 | 7 | 8 | 9 | 10 |
|---|---|---|---|---|---|---|---|---|---|---|
| Omyacarb 5 GU | 70 | 70 | 70 | 70 | 72 | 76 | 70 | 72 | 72 | 70 |
| Wetting agent | — | 0.1 | 0.3 | 0.9 | 0.3 | 0.3 | 1.5 | 0.3 | 0.3 | 0.3 |
| Plasticizer | 12 | 11.9 | 11.7 | 11.1 | 14.5 | 14.5 | 10.5 | | | 11.7 |
| Diisooctyl adipate | | | | | | | | 15.5 | | |
| Solusolv ® 2075 | | | | | | | | | 15.5 | |
| SH1 | 10 | 10 | 10 | 10 | 11.2 | 7.2 | 10 | 10.2 | 10.2 | |
| SH2 | | | | | | | | | | 10 |
| TM | 6 | 6 | 6 | 6 | | | 6 | | | 6 |
| Silquest ® A-171 | 1.5 | 1.5 | 1.5 | 1.5 | 1.5 | 1.5 | 1.5 | 1.5 | 1.5 | |
| Dynasylan ®VTEO | | | | | | | | | | 1.5 |
| Silquest ® A-1110 | 0.5 | 0.5 | 0.5 | 0.5 | 0.5 | 0.5 | 0.5 | 0.5 | 0.5 | |
| Dynasylan ®AMEO | | | | | | | | | | 0.5 |
| DBU | 0.04 | 0.04 | 0.04 | 0.04 | 0.03 | 0.03 | 0.04 | 0.04 | 0.04 | 0.04 |
| Tyzor ® IBAY | | | | | | | | | | 0.5 |
| Tensile strength | n.m. | n.m. | 1.3 | 0.7 | 1.4 | 1.7 | 0.6 | 1.3 | 1.5 | 1.5 |
| [MPa] | | | | | | | | | | |
| Elongation at | n.m. | n.m. | 40 | 54 | 27 | 23 | 160 | 28 | 25 | 45 |
| break [%] | | | | | | | | | | |
| Shore A | n.m. | n.m. | 70 | 60 | 79 | 79 | 44 | 75 | 78 | 71 |
| Skin formation | n.m. | n.m. | 20 | 50 | 25 | 25 | 60 | 20 | 30 | 40 |
| time [min] | | | | | | | | | | |
| Extrusion | n.m. | n.m. | 465 | 597 | 737 | 803 | 660 | 615 | 789 | 508 |
| pressure [N] | | | | | | | | | | |
| Density [kg/l] | 1.79 | 1.79 | 1.79 | 1.79 | 1.83 | 1.90 | 1.79 | 1.83 | 1.83 | 1.79 |

1. A moisture-cure composition, comprising
a) at least one silane-functional polymer P,
b) at least one catalyst for the cross-linking of silane functional polymers, and
c) at least 65% w/w of at least one filler,
wherein the composition in the fully cured state has a Shore A hardness of ≧60, determined according to DIN 53505, and prior to curing has an extrusion pressure of ≦1000 N, determined by the method stated in the description.

2. The moisture-cure composition according to claim 1, wherein the silane functional polymer P is selected from then group consisting of
a silane-functional polyurethane polymer P1 obtained by reacting a silane having at least one group that is reactive toward isocyanate groups with a polyurethane polymer containing isocyanate groups,
a silane functional polyurethane polymer P2 obtained by reacting an isocyanatosilane IS with a polymer containing functional end groups that are reactive toward isocyanates, or
a silane functional polyurethane polymer P3 obtained by a hydrosilylation reaction of polymers with terminal double bonds.

3. The moisture-cure composition according to claim 1, wherein the catalyst for cross-linking of silane functional polymers is an organotitanate, an amidine or a combination of the two.

4. The moisture-cure composition according to claim 1, wherein the composition comprises no organotin compounds for cross-linking the silane functional polymers.

5. The moisture-cure composition according to claim 1, wherein the composition comprises no constituents that split off methanol when curing.

6. The moisture-cure composition according to claim 1, wherein the composition comprises no phthalate-containing plasticizers.

7. The moisture-cure composition according claim 1, wherein the composition comprises a fatty acid alkyl ester as a plasticizer.

8. The moisture-cure composition according to claim 1, wherein the composition also comprises a wetting agent and/or dispersant.

9. The moisture-cure composition according to claim 1, wherein following curing, the composition has a density of ≧1.75 kg/l.

10. The moisture-cure composition according to claim 1, comprising up to 15% w/w of a silane functional polymer P,
70 to 80% w/w calcium carbonate as filler,
5 to 20% w/w of at least one plasticizer, and at least one catalyst for cross-linking the silane functional polymer, wherein the composition in the fully cured state has a Shore A hardness of ≧60, determined according to DIN 53505, and prior to curing, has an extrusion pressure of ≦1000 N, determined by the method stated in the description.

11. An adhesive, sealant or coating comprising the moisture-cure composition according to claim 1.

12. The adhesive, sealant or coating of claim 11, wherein the adhesive is a parquet adhesive.

13. A cured composition obtained by curing the composition according to claim 1 with water.

14. The cured composition according to claim 13, wherein the cured composition has a Shore A hardness of ≧60, determined according to DIN 53505.

15. The cured composition according to claim 13, wherein the cured composition has a density of ≧1.75 kg/l, measured according to DIN 53479.

16. The moisture-cure composition of claim 10, wherein the silane functional polymer P is a silane functional polyurethane polymer P1.

17. The moisture-cure composition of claim 10, wherein the at least one plasticizer is a fatty acid alkyl ester.
